(19) United States
(12) Patent Application Publication
(10) Pub. No.: US 2026/0267964 A1
(43) Pub. Date: Sep. 10, 2026

(54) System and method for preventing ransomware and other malware.

(71) Applicant: William Charles Easttom II, Plano, TX (US)

(72) Inventor: William Charles Easttom II, Plano, TX (US)

(21) Appl. No.: 19/095,733

(22) Filed: Mar. 31, 2025

Related U.S. Application Data
(60) Provisional application No. 63/768,126, filed on Mar. 6, 2025.

(51) Int. Cl. G06F 21/54; G06F 21/55; G06F 21/56

(52) U.S. Cl. CPC G06F 21/54; G06F 21/554; G06F 21/568

(57) ABSTRACT

The current invention discloses a system and methods for preventing ransomware and other malware using a technique of interrupting the start of a process, performing two or more checks, and making a backup of sensitive data before allowing a process to launch.

### CROSS REFERENCE TO RELATED APPLICATIONS

This application claims priority from the U.S. provisional patent application No. 63/768,126 filed on Mar. 6, 2025 and is incorporated herein by reference in its entirety.

### GENERAL DESCRIPTION

1) Ransomware is a very serious problem, and one that does not show any indications of abating. Ransomware is a type of malicious software (malware) designed to deny access to a victim's data until a fee (ransom) is paid. The most common type of ransomware encrypts files then demands ransom from the victim in order to provide the key to decrypt. It is also quite common for threat actors to exfiltrate the data prior to encrypting it and then threaten to release all the data publicly if the ransom is not paid.

2) In 2024, the ransomware ecosystem expanded markedly, with 46 new groups emerging, a 48% increase in active groups compared to the previous year. This growth underscores the resilience of ransomware operators, even amid intensified law enforcement actions and technological countermeasures. Notably, the total number of active ransomware groups reached 95 in 2024, up from 68 in 2023. New entrants like RansomHub have become dominant forces, surpassing well-established groups such as LockBit in activity.

3) A significant shift in ransomware tactics has been observed, with at least 80% of attacks in 2024 focusing solely on data exfiltration without encrypting data. This approach is approximately 34% faster, allowing threat actors to expedite their operations and reduce the likelihood of detection.

4) To illustrate the growing danger of ransomware, three major ransomware outbreaks will be analyzed. The first example of ransomware is BlackBasta. This ransomware was initially discovered in April of 2022. One of the distinctions that make this ransomware notable is that there are variants for Linux as well as Windows. When on a Windows domain controller, Black Basta will create a group policy to disable Windows Defender and other anti-virus solutions. This is a particularly malicious aspect of the virus. Like many modern ransomware variants, this ransomware first steals data, then encrypts the computer files demanding ransom. The perpetrators will begin leaking stolen data if the ransom is not paid.

5) In 2022 Mindware was discovered and quickly spread. Among other targets, Mindware was used against nonprofit mental health providers. As is becoming common with ransomware, Mindware would first steal data, then encrypt the files on the victims computers. Data from victims in the financial and manufacturing industries that was stolen by Mindware has been posted to the internet. Each Mindware payload is configured for a particular target. This is rather unusual in the ransomware arena. Once the target is infected, the payload drops a hardcoded ransomware note demanding payment and discouraging attempts to circumvent the ransomware.

6) Clop was first seen in 2019 as a variant on the CryptoMix ransomware family. Sometimes spelled Cl0p with a zero rather than an o. The CryptoMix family of ransomware first began to be seen in 2016. Clop began to show up widely in 2021. In addition to encrypting files, Clop also blocks about 600 Windows process. Estimates are that over $500 million was paid out in ransom as of November 2021 due to Clop. New variations of Clop are attacking the entire network. An interesting aspect of Clop is that it operates as Ransomware as a Service.

7) It should be noted that ransomware is not new. The first known ransomware was the 1989 PC Cyborg Trojan, which only encrypted filenames with a weak symmetric cipher. The notion of using public key cryptography for these attacks was introduced by Young and Yung in 1996

8) While the current invention specifically describes remediation steps for ransomware, one skilled in the art would understand that the system and methods described herein could also be applied to any type of malware including but not limited to viruses, Trojan horses, spyware, rootkit, botnet, backdoor, logic bomb, etc.

9) Malware in general, including viruses, worms, and ransomware, has been a problem for a long time. In 1971, Bob Thomas created what is widely believed to be the first computer virus, named Creeper. It spread through the ARPANET (the precursor to the Internet) and displayed a message “I'm the creeper, catch me if you can!” Another program, named Reaper, was created to delete Creeper. Wabbit, which was found in 1974, made multiple copies of itself, thus adversely affecting the performance of the infected computer.1981 Apple Viruses 1, 2, and 3 are some of the first viruses “in the wild” or public domain. Found on the Apple II operating system, the viruses spread through Texas A&M via pirated computer games.

10) In March of 1988, the first anti-virus software was written. It was designed to detect and remove the Brain virus and immunized disks against Brain infection. Symantec released Norton anti-virus in 1991.

11) In general, any unwanted program, otherwise known as malware, must first be downloaded to a machine and then at some point launched. Current antimalware efforts focus on determining if a particular file is malware. This can be done by attempting to match the files characteristics, such as a cryptographic hash of the file, to known malware. Another technique is to observe the activites the file attempts to execute to determine if said activites are indicative of malware. Other methods involve machine learning to assist the anti-malware methods in improving their efficacy. However, these methods have only had limited success.

12) Users can be tricked into downloading and installing software, for example via phishing emails. Making the user believe that the malware is actually a system patch, or legitimate software is a common technique used by malicious actors. This is typically referred to as a Trojan horse. A Trojan Horse (Trojan) is a type of malware that disguises itself as a legitimate or harmless program to trick users into executing it. Therefore, a user might install malware believing it to be legitimate software.

13) It is also the case that malware can be injected into legitimate software using techniques such as process hollowing. Process Hollowing is a stealthy code injection technique used by malware to evade detection. It involves creating a legitimate process in a suspended state, removing its original code, and injecting malicious code into its memory space. This allows attackers to execute harmful operations under the disguise of a trusted process. This can work in different ways, one common way begins with the attacker spawning a benign process (e.g., explorer. exe or svchost. exe) in a suspended state using CreateProcess in Windows. The original executable code is removed from memory, leaving an empty memory space. The malware injects its own code into the hollowed process using VirtualAllocEx (to allocate memory) and WriteProcessMemory (to write the malicious payload). The process is resumed using ResumeThread, making it appear as a legitimate running process while executing the attacker's code.

14) There are a number of techniques related to process hollowing including process injection, DLL Injection, thread hijacking, process Doppelgänging, and others. DLL Injection is a technique used by attackers (or sometimes legitimate software) to insert a dynamic link library (DLL) into the memory space of another process. This allows the injected code to execute within the context of the target application, often enabling the attacker to manipulate its behavior. Thread Hijacking is a technique used by attackers to gain control over a running process by manipulating its threads. Instead of creating a new malicious thread, the attacker takes over an existing one within a legitimate process and executes malicious code in its context. This method is often used for stealthy code execution, as it avoids creating new threads that security tools might detect.

15) Process Doppelgänging is an advanced code injection technique used by attackers to execute malicious code while evading security software. This method exploits the way Windows manages transactions in the NTFS file system, allowing malware to disguise itself as a legitimate process without leaving conventional forensic traces.

16) All of these techniques share the common issue that they find a way for malware to either take over some legitimate software, or to appear to be legitimate software. These techniques make file matching an ineffective means of detecting malware. These techniques make identification of malware more challenging.

17) There are currently several methodologies used to detect malware. Two of the most common are signature based and heuristic. Other methods include sandboxing,

18) Signature-based detection is one of the most common and reliable methods used by antivirus software to identify known malware. This technique works by comparing files, programs, or code fragments against a database of unique digital fingerprints (signatures) of previously identified malware. This requires that a signature of the malware be known, and is not effective against new malware.

19) Heuristic virus detection is a method used by antivirus software to identify potentially malicious files or behaviors that may not yet be recognized in traditional virus signature databases. Unlike signature-based detection, which relies on predefined patterns of known viruses, heuristic analysis looks for suspicious characteristics, behaviors, or code structures that might indicate the presence of a virus. However, this requires that the suspect file actually execute in order for detection to occur.

20) Sandboxing is an advanced malware detection technique that runs suspicious programs in an isolated, controlled environment to observe their behavior before allowing them to execute on a real system. This method is particularly effective in detecting zero-day threats, polymorphic malware, and sophisticated cyberattacks that evade traditional detection techniques. However, this technique requires isolating any suspected file for a period of time in order to perform analysis.

21) The current invention focuses on when a process starts. Whether that process is a legitimate process, or malware, the current invention interrupts the start of the program to ensure that the program should be starting. Then, if needed, the current invention makes a backup of sensitive or important files to a secure location so that if the process is ransomware, and encrypts the data, these sensitive files were backed up immediately prior to the data encryption, thus allowing the organization to retrieve their data without paying ransom.

22) This is a two-fold approach, first focusing on preventing ransomware or other malware from launching, and secondly making an immediate backup before it launches in order to protect the data.

### PRIOR ART

23) U.S. Pat. No. 11,888,892B2 (“Jevans”) is directed towards detecting cryptocurrency-based malware, including ransomware. This patent is concerned with analyzing URL's, ransom notes, and other artifacts after malware has infected the system. However, this patent does not address preventing the malware from encrypting the files, thus making the ransomware ineffective.

24) U.S. Pat. No. 10,169,586B2 (“Maciejak”)relies on the addition of a kernel module driver to detected directory traversal. One of skill in the art would recognize that altering the kernel of an operating system is a non-trivial task, and one that end users can only do with open-source operating systems. Furthermore, unlike the present invention, this patent depends on a decoy file in each directory. The decoy file is key to detecting malware activity. Furthermore, Maciajak will only be effective against specific malware techniques such as directory traversal.

25) U.S. Pat. No. 10.607,009B2 (“Dahan”) depends entirely on the use of a honeypot. A honeypot is a security mechanism used to detect, deflect, or study attempts at unauthorized access to information systems. It is essentially a decoy system or resource designed to mimic a legitimate target that would attract attackers. Honeypots serve several purposes, including gathering intelligence about cyber threats, identifying vulnerabilities, and improving an organization's security posture. However, as with all honeypots, Dahan does not prevent malware from being launched on a device, nor does it protect sensitive data.

26) U.S. Pat. No. 10,229,269B1 (“Patton”) is focused on detecting if a process is opening a file to edit it. This patent also has a method for detecting that a file has been encrypted. One of skill in the art would realize that files are quite frequently edited, leading to this approach providing a large number of false positives. Furthermore, ransomware encrypting files is not editing. Thus, Patton would be unlikely to prevent or even mitigate ransomware.

27) European Patent EP3777076B1 (“Chelarescu”) seeks to detect changes to a file. The specific focus in on “file churn” or the number of files changed in a given period of time. Detecting changes in a file would not prevent ransomware from encrypting a file. In fact, such changes would only be detected after the ransomware had encrypted files.

28) U.S. Pat. No. 11,977,630B2 (“Mehta”) checks to see if a file is being written to or created, and checks if the file is encrypted. If the requisite conditions are met there may be a cloud backup with changing the file extension. However, this patent has a process that would be far more laborious and intrusive than the current invention, and indeed would not have all the features of the current invention.

29) U.S. Pat. No. 9,807,115B2 (“Kolton”) utilizes one or more decoy drives, and a trap with deceptive information to attract ransomware to that decoy drive. Kolton then continues providing decoy files, thus keeping the ransomware active on the decoy drive. While this is an interesting approach, it is a completely different approach than the current invention. Kolton does not determine if a process is allowed, nor does Kolton make an emergency backup of sensitive files.

30) U.S. Pat. No. 10,607,009B2 (“Dahan”) is a rules-based system. It has a set of rules for attempting to identify ransomware based on the files activity. This necessitates allowing the process to execute in order to analyze its activity. Dahan includes a number of optional features such as the use of a honeypot. Dahan does disclose making a backup of data when an access request is made but does not disclose disconnecting said backup. Nor does Dahan disclose making a backup prior to the suspect program even launching.

31) U.S. Pat. No. 10,121,003B1 (“Adams”) functions by detecting entropy of files, indicating encryption. This particular approach can only attempt to mitigate ransomware, after the ransomware has already begun encrypting files. It may be able to step the ransomware from encrypting all the files, but at least some will be encrypted. This approach lacks the features and benefits of the current invention including stopping the ransomware before any files are encrypted and making a backup of the files so that they are available even if the ransomware evades detection.

32) U.S. Pat. No. 11,531,757B2 (“Kamik”) focuses on detecting ransomware by the activity of the suspect ransomware. This involves detecting if a process is creating a file or changing the file type. This means the ransomware must begin operation before it can be detected. Kamik mitigates the ransomware by detaching the affected machine from the network thus preventing the ransomware from spreading on the network. However, the infected machine will have at least some data encrypted before detection, making that data irretrievable.

33) U.S. Pat. No. 11,113,156B2 (“Brewer”) is focused on recovery from a ransomware event. Much of Brewer discusses the context of disaster recovery. Claim 1 of Brewer describes detecting malicious activity in data that has already been backed up. While Brewer may present a viable recovery system, it does not prevent the ransomware from executing and encrypting data initially.

34) U.S. Pat. No. 8,381,298B2 (“Blumfield”) focuses on isolating content that has a likelihood of containing malware for a period of time. During that period of time heuristics and signatures are applied in an attempt to determine if the file is malware.

35) U.S. Pat. No. 9,317,686B1 (“Ye”) uses behavior to detect ransomware. This necessitates allowing the ransomware to function for a brief period of time to detect it. This is actually stated in Ye “using behavior-based detection, ransomware can be blocked soon after it begins to encrypt a certain number of files . . . ”. Ye will not prevent the ransomware from beginning its encryption activities. While Ye does disclose backing up files, it detects ransomware while files are being backed up. This means that at least some files are already encrypted and may be unrecoverable.

36) U.S. Pat. No. 9,760,715B2 (“Rothwell”) detects the attempt to write something to the storage device. This is done via a filter module that monitors input/output. This patent does not disclose monitoring processes starting nor does it disclose backup of sensitive files, or other aspects of the current invention

37) U.S. Pat. No. 10,530,802B2 (“Thomas”) discloses allowing a file to execute for a period of time, then ending the execution to create a memory map of what occurred while the file was executing. That memory map is then stored for analysis. This is a time-consuming method that does allow the suspect file to execute for a period of time. This patent does not disclose interrupting the launch of a process in order to test or evaluate the process, or other aspects of the current invention.

38) U.S. Pat. No. 7,725,941B1 (“Pavlyushchik”) has two modalities, one for known files one for unknown. For known files, the file is checked against signature to determine that it is or is not malware. For unknown files a risk analysis is done to determine if it is likely to contain malware. Risk analysis includes checking if the file is digitally signed, where the file originated, and using known malware detection algorithms. While Pavlyushchik does mention digital signatures, they are not validated prior to allowing a process to launch.

39) U.S. Pat. No. 7,870,612B2 (“Liu”) focuses on identifying malware via behavior analysis, specifically utilizing a Process Behavior-Evaluating Unit, a Program-Monitoring Unit, a Correlation-Analyzing Unit, a Virus-Identifying Knowledge Base, and a Virus-Identifying Unit. One of skill in the art would readily recognize that Liu takes an entirely different approach than does the current invention.

40) U.S. Pat. No. 12,013,937B1 (“Oliver”) is a type of signature matching. Rather than simple matching of a file hash, Oliver uses a hierarchical evolutionary tree of digests/hashes of sample files. These digests/hashes are grouped into clusters which are in turn grouped into nodes. A digest of a file being evaluated for malware is generated using the locality sensitive hashing function. The digest is put in a cluster of the hierarchical evolutionary tree having digests that are most similar to the digest relative to digests of other clusters of the hierarchical evolutionary tree. The digest is identified to be of the same malware family as the digests of the cluster. One of skill in the art would readily recognize that Liu takes an entirely different approach than does the current invention. One of skill in the art would readily recognize that Liu takes an entirely different approach than does the current invention.

41)U.S. patent application 20,190,243,975A1 (“Schmugar”) examines startup hooks that may be created by malware to assist in ensuring that the malware is started upon a reboot of a programmable device. The startup hooks help form a reputation associated with a target executable.

42) The NIST Special Publication 800-83 Guide to Malware Incident Prevention and Handling for Desktops and Laptops describes a range of techniques including content filtering, whitelisting, sandboxing, segregation, and others. While this document does describe data backups, it does not disclose backing up data prior to launching a process. Furthermore, this document does not disclose interrupting the launch of a process in order to test or evaluate the process, or other aspects of the current invention.

43) Jain and Bajaj conducted a survey of malware detection techniques. Their survey included behavior based techniques, survey based techniques, but did not disclose interrupting the launch of a process in order to analyze the process, backing up data prior to the launch of the process, or other aspects of the current invention. Jain, M., & Bajaj, P. (2014). Techniques in detection and analyzing malware executables: a review. International Journal of Computer Science and Mobile Computing, 3(5), 930-935. https://d1wqtxts1xzle7.cloudfront.net/33820434/V3I5201499a68-libre. pdf? 1401350144=&response-content-disposition=inline%3B+filename%3DTechniques_in_Detection_and_Analyzing_Ma.pdf

44) Jawad and Ahmed explored the use of machine learning to detect ransomware. Their survey examined a number of machine learning techniques. However, it did not disclose interrupting a process to examine it, backing up the data prior to the process launching, or other aspects of the current invention. Jawad, S., & Ahmed, H. M. (2024). Machine Learning Approaches to Ransomware Detection: A Comprehensive Review. International Journal of Safety & Security Engineering, 14(6). https://www.researchgate.net/profile/Hanaa-Ahmed-Salman/publication/ 387695399_Machine_Learning_Approaches_to_Ransomware_Detection_A_Comprehensive_Review/links/677e4f3dfb021f2a47e1ee72/Machine-Learning-Approaches-to-Ransomware-Detection-A- Comprehensive-Review. pdf

### DETAILED DESCRIPTION

45) One aspect of the current invention is to detect any process when it begins and determine if that process has been previously approved. A computer process is a program or a piece of software that is currently being executed by the CPU (Central Processing Unit) of a computer. It represents a running instance of a program, which includes the program's code, data, and any state information required for execution. Often times each process on a computer is kept in a separate memory address from other running processes.

46) An example of Python code to detect when a new process is started in Windows is shown here:
import psutil
import time
def detect_new_processes( ):
“““Detects newly started processes on Windows.”””
#Get the initial set of processes
initial_processes=set(p.info[‘pid’] for p in psutil.process_iter([‘pid’]))
while True:
time.sleep(1) #Check every second (adjust as needed)
current_processes=set(p.info[‘pid’] for p in psutil.process_iter([‘pid’]))
new_processes=current_processes-initial_processes
if new_processes:
   for pid in new_processes:
      try:
      process=psutil. Process(pid)
      print(f“New process detected: PID={pid}, Name={process.name( )}”)
      #Add more details if required
      #print(process.cmdline( ))
      #print(process.exe( ))
   except (psutil. NoSuchProcess, psutil.AccessDenied, psutil. ZombieProcess):
      #Handle potential exceptions (process might have ended before we could get info)
      print(f“Could not retrieve information for PID={pid}”)
   initial_processes=current_processes #Update the initial set for the next iteration
if__name__==“__main__”: detect_new_processes( )

47) One of skill in the art would recognize that this is just an example of one way to detect a process. There are other ways to do this in code. The following code is example code of one way one might detect a currently running process in Linux:
import psutil
import time
def detect_new_processes( ):
“““Detects new processes started in Linux.”””
previous_processes=set(p.pid for p in psutil.process_iter( ))
while True:
current_processes=set(p.pid for p in psutil.process_iter( ))
new_processes=current_processes-previous_processes
for pid in new_processes:
try:
   process=psutil.Process(pid)
   print(f“New process started: PID={pid}, Name={process.name( )}”) except psutil. NoSuchProcess:
   print(f“Process {pid} already terminated.”)
   continue
previous_processes=current_processes
time.sleep(1) #Check for new processes every second
if__name__==“__main__”:
detect_new_processes( )

48) One of skill in the art would recognize that this is just an example of one way to detect a process. There are other ways to do this in code. Yet another way in the Linux operating system is shown here:
#include <stdio.h>
#include <stdlib.h>
#include <string.h>
#include <dirent.h>
#include <unistd.h>
#include <sys/types.h>
#include <errno.h>
#define MAX_PIDS 32768// Maximum number of PIDs (adjust if necessary)
int known_pids[MAX_PIDS]={0}; // Track known PIDs
// Function to check if a string is a number (used to filter/proc entries)
int is_number(const char *str) {while (*str) {if (*str<‘0’ ||*str>‘9’) return 0; str++; } return 1; }// Function to scan/proc for active PIDs void scan_proc( ) {struct dirent *entry; DIR *proc_dir=opendir(“/proc”); if (! proc_dir) {perror(“Failed to open/proc”); exit(EXIT_FAILURE); } while ((entry=readdir(proc_dir)) !=NULL) {if (is_number(entry->d_name)) {int pid=atoi(entry->d_name); if (pid >0 && pid <MAX_PIDS) {if (! known_pids[pid]) {// New process detected printf(“New process detected: PID %d\n”, pid); known_pids[pid]=1; } } } } closedir(proc_dir); } // Function to initialize known PIDs void initialize_known_pids( ) { memset(known_pids, 0, sizeof(known_pids)); scan_proc( ); // Populate known_pids with existing PIDs } int main( ) {printf(“Monitoring for new processes . . . \n”); initialize_known_pids( ); while (1) { sleep(1); // Adjust polling frequency scan_proc( ); } return 0; }

49) The system and methods of the current invention detect when a process is starting. The system and method of the current invention interrupt that launch, for example by using code similar to the three examples that were described in the preceding paragraphs. Once the launch of the program is halted, one or more checks are performed.

50) Once a process is detected it can be compared to either a whitelist or blacklist. Whitelist and Blacklist are two common security concepts used to control access to resources, systems, or services by allowing or denying specific entities based on predefined rules. A whitelist is a list of approved entities (such as users, IP addresses, email addresses, applications, or domains) that are explicitly allowed to access a resource or perform an action. Only entities on the whitelist are granted access, while all others are denied by default. A blacklist is a list of blocked entities that are explicitly denied access to a resource or service, while all others are allowed by default. Any entity on the blacklist is denied access, but those not on the list are allowed to proceed.

51) One of skill in the art will appreciate that a whitelist is more secure, and thus preferable, but also more restrictive. Therefore, some implementations of the current invention may be accomplished with a blacklist.

52) The check could also be to determine if the process has a valid digital signature. A digital signature is a cryptographic technique used to verify the authenticity, integrity, and non-repudiation of digital messages, documents, or software. It ensures that data has not been tampered with and confirms the identity of the sender. Digital signatures rely on public-key cryptography (asymmetric encryption). The process involves two cryptographic keys: a private Key (used to sign the message) and a public Key (used to verify the signature). The steps in Digital Signature Generation & Verification are given here:
Hash the Message-The sender creates a cryptographic hash of the message.
Encrypt with Private Key—The hash is encrypted using the sender's private key, creating the digital signature.
Attach Signature to Message—The signature is appended to the original document or message.

Verify Signature:
The receiver decrypts the signature using the sender's public key, obtaining the original hash.
The receiver generates a new hash from the received message.
If both hashes match, the signature is valid, confirming authenticity and integrity.

53) The following code is an example of how one might validate a digital signature:
#include <stdio.h>
#include <stdlib.h>
#include <string.h>
#include <openssl/pem.h>
#include <openssl/evp.h>
#include <openssl/err.h>
// Function to read a file into a buffer unsigned char*read_file(const char*filename, size_t*len) { FILE *file=fopen(filename, “rb”); if (!file) {perror(“Failed to open file”); return NULL; }

54) As with other code samples, the preceding is just an example. One of skill in the art would recognize that there are numerous methods for validating a digital signature.

55) Whether a blacklist, whitelist, or digital signature is used, if the process passes the check, there is then a check to determine if this is the first time this process has been launched on this computer. If this is the first time launching this program, then a manual, human approval is required. The most secure modality would be one in which an administrator is notified of the program launching and must manually approve. However, this may not be viable for all situations, particularly home uses. Therefore, it is possible to implement the current invention with the approval simply being a yes or no from the user.

56) One of skill in the art will understand that it may be advantageous to have both a check against a whitelist and a digital signature check, in addition to the manual check. This would provide the highest confidence that the process is legitimate.

57) Regardless of the check that is performed (blacklist, whitelist, digital signature, and/or manual), a failed check will result in both logging the failure as well as an alert. That alert could be a windows popping up on the device; a notification to a system administrator such as a text message, email, or network message; or any similar message that would alert someone responsible for the machine that a process has failed one or more checks. Exemplary code to log an event is shown here:
import logging
from datetime import datetime
#Configure logging
logging. basicConfig(
   filename=“event_log.log”, #Log file name
   level=logging. INFO, #Logging level
   format=“%(asctime)s-%(levelname)s-%(message)s”,
   datefmt=“%Y-%m-%d %H: %M: %S”, )
def log_event(event_type, description, severity=“INFO”): “““ Logs an event with details. :param event_type: Type of event (e.g., “UNAUTHORIZED PROCESS DETECTED”, “ERROR”, “WARNING”) :param description: Description of the event :param severity: Log level (INFO, WARNING, ERROR, CRITICAL) ”””
message=f“{event_type}—{description}”
if severity. upper( )==“INFO”:
   logging. info(message)
elif severity. upper( )==“WARNING”:
   logging. warning(message)
elif severity. upper( )==“ERROR”:
   logging. error(message)
elif severity. upper( )==“CRITICAL”:
   logging. critical(message)
else:
logging.debug(message) #Default to DEBUG level if an unknown severity is passed
   print(f“[{datetime.now( ).strftime(‘%Y-%m-%d %H: %M: %S’)}] {severity.upper( )}—{message}”)
#Example usage
Log_event(“user_login”, “unauthorized Process Detected.”)

58) One of skill in the art would recognize that the preceding is just one example of how one might log an event.

59) After the checks are done, if it has been determined to allow the process in question to begin, the current invention will make a backup of any files that have been previously marked as sensitive. The purpose of this backup is that if, after all the checks performed, the process is indeed ransomware, the sensitive files have been backed up, thus should the ransomware encrypt files or even an entire drive, the files are backed up immediately before the encryption process allowing the data to be restored without paying ransom.

60) The implementation of the system for interrupting a process launching and performing the checks described in the current invention is named a process control module in the current invention. One of skill in the art would realize that other names could be used for implementations of this invention.

61) One of skill in the art will appreciate that there are numerous methods for performing the alert after a check. Whether the check is against a blacklist, a whitelist, checking a digital signature, or a similar method, the alert could be a simple message to the user of the current computer; and/or could be an alert to an administrator.

62) The process of backing up sensitive files requires that a user or administrator first identify those files that are to be backed up. Then, before a process is launched, these files will be backed up to the previously designated location. This can be a full backup, differential backup, or incremental backup. One of skill in the art will appreciate that an incremental backup will be the fastest. After the files are backed up it is advantageous to disconnect from the backup location before launching the process in question. In this way, should the process indeed by ransomware, despite the double checks, sensitive files are recoverable without paying the ransom. The following code is exemplary Python code that can be used to disconnect a network drive:
Import subprocess
def disconnect_network_drive(drive_letter)
“““Disconnects a mapped network drive :param drive_letter: The drive letter to disconnect (e.g., ‘Z:’) ”””try: command=f‘net use {drive_letter}/delete/y’ result=subprocess.run(command, shell=True, capture_output=True, text=True) if result.returncode==0: print(f“Successfully disconnected {drive_letter}”) else: print(f“Error disconnecting {drive_letter}: {result.stderr}”) except Exception as e: print(f“Exception occurred: {e}”) #Example usage disconnect_network_drive(“Z:”)

63) The preceding code is just an example. Similar code can be written in a variety of programming languages and may not use a network drive. For example, the following code sample is C++ code to disconnect a USB drive:
#include <iostream>
#include <fstream>
#include <cstdlib>
void disconnectUSBDrive(const std:: string& driveLetter) {// Create a temporary diskpart script file std:: ofstream scriptFile(“disconnect_usb. txt”); if (! scriptFile) {std::cerr <<“Error creating script file!” <<std::endl; return;} scriptFile <<“remove letter=” <<driveLetter <<std::endl; scriptFile <<“exit” <<std:: endl; scriptFile. close( ); // Execute diskpart with the script file std:: string command=“diskpart /s disconnect_usb.txt”; int result=std::system(command.c_str( )); // Clean up script file std::remove(“disconnect_usb.txt”); // Check result if (result==0) {std::cout <<“Drive” <<driveLetter <<“has been disconnected successfully.” <<std::endl;} else {std::cerr <<“Failed to disconnect drive” <<driveLetter <<“.” <<std::endl; }}
int main( ) {// Example: Disconnect drive E: disconnectUSBDrive(“E”); return 0; }

64) These are just samples meant to illustrate various ways in which elements of the current invention could be implemented.
65) What files are to be backed up will be identified by configuring the current invention. There is a user interface that allows the user of the current invention to configure the invention. Said configuration includes identifying what files are to be backed up, what type of backup is to be done, as well as what checks are to be performed.
66) Stopping every process before it starts could be cumbersome for a standard workstation. However, one of skill in the art would appreciate that this would not be an issue for servers. A server is normally kept running for an extended period of time. Furthermore, a server is typically directed towards a specific task such as serving data, web pages, domain name service, etc. With such servers there is normally not new processes frequently launching. The brief delay of approving a new process, and waiting while sensitive data is backed up is more than outweighed by protecting the data from ransomware attacks.

### DESCRIPTION OF FIGURES

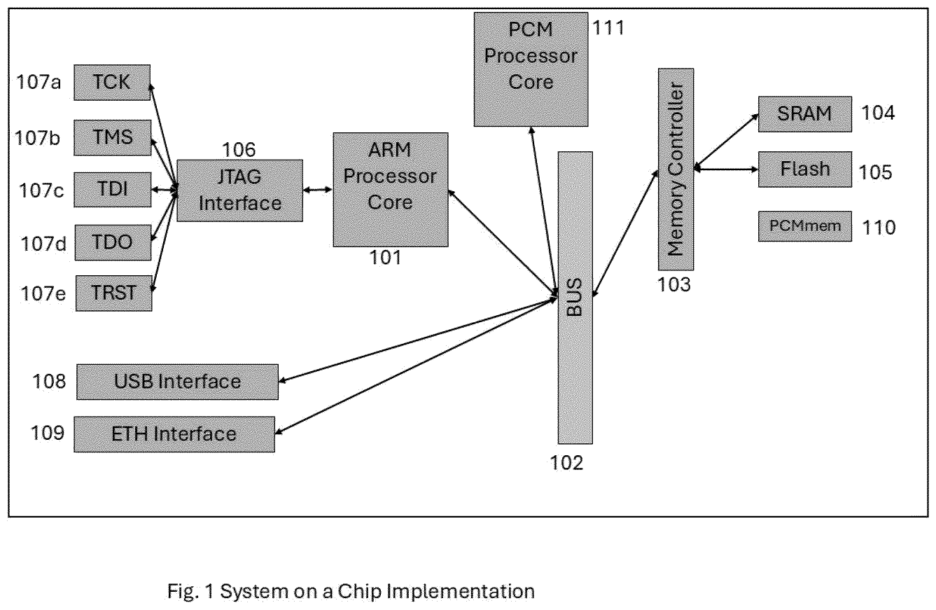

67) FIG. 1 is an exemplary diagram of a System on a Chip implementation of the current invention. In this embodiment, the process control module could be implemented as firmware in the SRAM or Flash. 101 is an ARM (advanced RISC machine) Processor core, one if skill in the art would understand that other processor architectures are also possible. 102 is a BUS connecting aspects of the System on a Chip; 103 is the memory controller, exemplary memory types such as SRAM (104) and Flash (105) are shown. One skilled in the art would understand that any suitable memory type can be used. 106 is the JTAG (Joint Test Action Group) interface found on many processors; 107a through 107e are exemplary TAPs (Test Access Points): test clock, test mode select, test data in, test data out, test reset. One of skill in the art would appreciate that additional TAPs may be present. 108 and 109 are exemplary external interfaces that may be present on some processors. The current invention could be implemented as firmware in the SRAM, or as an additional memory component as shown by 110. 110 depicts a dedicated memory component for the process control module (PCMmem). Alternatively, the current invention could be implemented as an additional processor shown by 111. 111 depicts a possible process control module processor (i.e. PCM processor core)

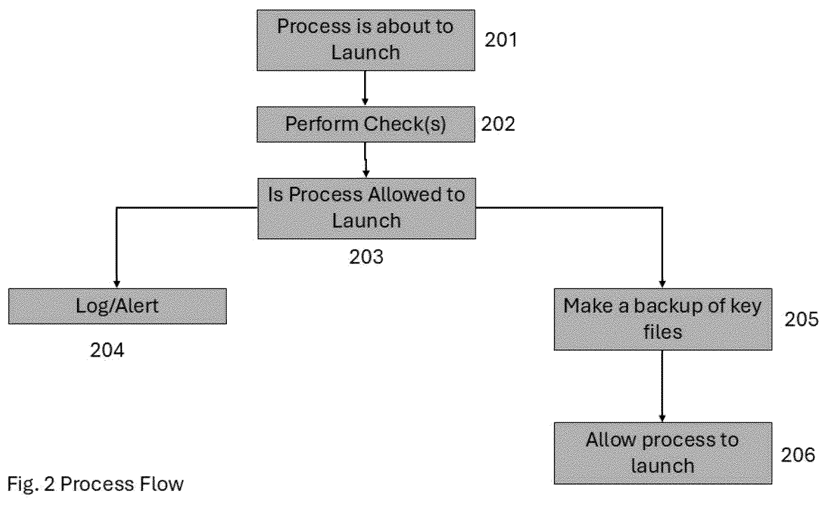

68) FIG. 2 is an overview of the process flow of the current invention. Item 201 is where the launch of the process is interrupted, as described earlier. Item 202 performs the various checks previously described. The first check being if this is the first time this process has been launched, and if so, getting manual approval for it to launch. The second check is either against a whitelist or a blacklist. Item 203 is the step at which a determination is made if this process should launch. If not, then item 204 is executed which provides a log of the details of the event and/or an alert. If the process is allowed to start step 205 allows performs a backup of previously identified sensitive files. Once the backup is complete, step 206 allows the process to start.

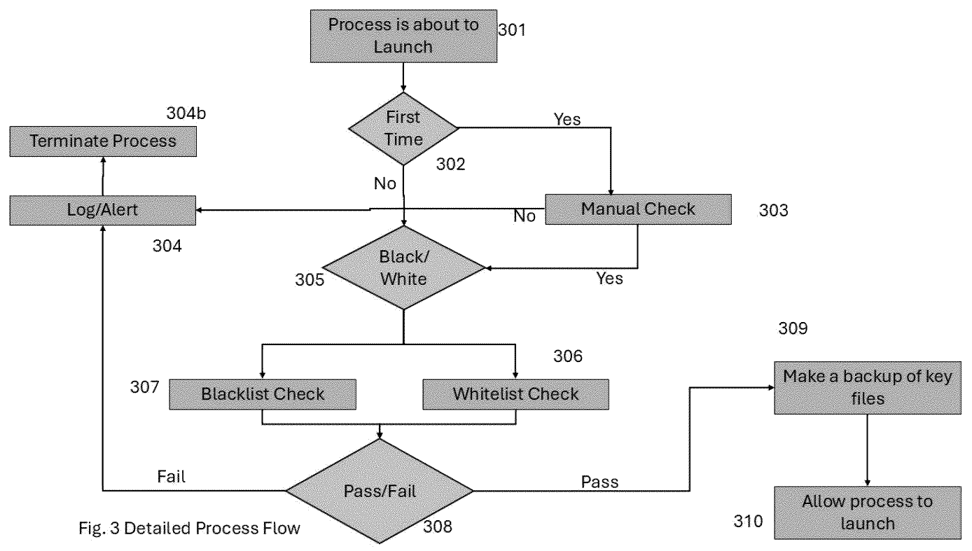

69) FIG. 3 is a more detailed flowchart. It encompasses the steps of FIG. 2 but provides more detail on the steps. Step 301 is a process about to launch. It is at this point that the launch is interrupted. At 302 a check is performed to see if this is the first time this process has ever been launched on this computer. If so, that will require step 303 which is a manual approval for the process to execute, followed by step 305 wherein the process is checked against a blacklist or whitelist. If this is not the first time this process has been launched, then the next step is 305, checking a blacklist or whitelist. One of skill in the art will appreciate that the check against a blacklist or whitelist could be done prior to the check to see if this is the first time this process has been launched on this device. If the manual check fails, or the blacklist/whitelist check fails, then control is passed to step 304, wherein the failed check is logged, and an alert is provided. Then step 304b is executed and the process is terminated. If the manual check and the blacklist/whitelist check both pass (step 308) control is passed to step 309 wherein files that have been previously identified as sensitive are backed up to a secure location. Furthermore, after that backup, step 308 will disconnect that backup location, then move to step 309 launching the process.

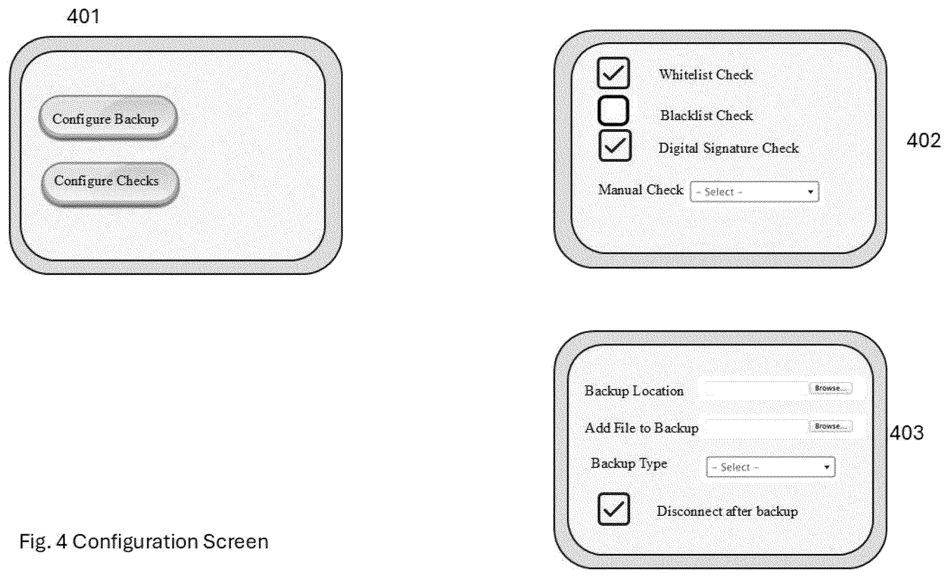

70) FIG. 4 is an example of what a configuration screen for the current invention would look like. 401 is the main screen from which one can select to configure the backup or to configure what checks are to be performed. 402 is the screen wherein one selects whether to do a whitelist or blacklist check, whether to perform digital signature validation, and which user(s) can perform the manual check. 403 is the backup configuration where a user can select the backup location and type, as well as add files to the backup. One of skill in the art will recognize that FIG. 4 is simply an example of one way the configuration screen could appear. Any suitable user interface could be used.

### EXEMPLARY EMBODIMENTS

71) In one embodiment the process control module would be implemented in a computer hardware device. One way the process control module could be implemented on hardware is via a system on a chip. A System on a Chip (SoC) is an integrated circuit (IC) that consolidates all the essential components of a computer or electronic system onto a single chip. This includes a processor (CPU), memory, input/output (I/O) interfaces, and other components, such as GPUs or communication modules, depending on the application.

72) Another way the process control module could be implemented on hardware is via an FPGA. A Field-Programmable Gate Array (FPGA) is a type of programmable integrated circuit that allows developers to configure its hardware functionality after manufacturing. Unlike traditional chips with fixed functionality (like CPUs or GPUs), FPGAs can be reprogrammed to perform specific tasks, making them highly versatile for a wide range of applications.

73) Yet another way the process control module could be implemented on hardware is via an ASIC. An Application-Specific Integrated Circuit (ASIC) is a custom-designed integrated circuit created for a specific application or function. Unlike general-purpose processors (e.g., CPUs or GPUs), ASICs are purpose-built to perform a specific task with maximum efficiency, speed, and performance. Once manufactured, an ASIC cannot be reprogrammed or repurposed for a different task.

74) Yet another way the process control module could be implemented on hardware is via an embedded chip. An embedded chip is a microchip designed to perform specific tasks within an embedded system. Embedded systems are specialized computing systems that operate within a larger device or product, typically with dedicated functionality. These chips are integral components in modern electronics, enabling devices to process data, control hardware, and communicate with other systems.

75) In another embodiment the process control module would be implemented as a software module. One way the process control module could be implemented in software would be via a DLL. Dynamic Linked Libraries (DLLS) are linked to an executable program at runtime rather than at compile time. Windows provides many system DLLs, like kernel32.dll (basic OS functionality) and user32.dll (GUI support). A DLL exposes its functions to other applications by “exporting” them, which is typically defined in the source code with special keywords or attributes (e.g., __declspec(dllexport) in C/C++). The following code is an example of how a DLL would export a function:
76)// mymath.c __declspec(dllexport) int add(int a, int b) {return a+b;} __declspec(dllexport) int subtract(int a, int b) {return a−b;}

77) Another way the process control module could be implemented in software would be via a shared object. A Shared Object (SO) file is the Linux and Unix equivalent of a Windows DLL (Dynamic Link Library). It is a compiled library file with a.so extension that contains machine code for functions, classes, or resources that can be used by multiple programs at runtime. The following is exemplary code demonstrating how shared objects are created:
//Sample Code to Create a Shared Object (.so) in Linux
//mylibrary.c
#include <stdio.h>
// Function to be exposed in the shared object void hello( ) { printf(“Hello from the shared library!\n”); }// Compile with: // gcc-fPIC-shared-o libmylibrary.so mylibrary. c // Usage in another program: /* #include <stdio.h>#include <dlfcn.h>int main( ) {void *handle=dlopen(“. /libmylibrary.so”, RTLD_LAZY); if (! handle) {printf(“Failed to load shared library\n”); return 1; }void (*hello)( )=dlsym(handle, “hello”); if (!hello) {printf(“Failed to find function\n”); dlclose(handle); return 1; }hello( ); dlclose(handle); return 0; }
// Compile the test program with:
// gcc-o test test.c-ldl
*/

78) Yet another way the process control module could be implemented in software would be via a kernel module. A Kernel-Level Module (KLM) is a piece of code that can be dynamically loaded into or removed from the operating system kernel at runtime. It is commonly used to extend the kernel's functionality without the need to reboot the system or modify the kernel itself. In Linux, these modules are typically referred to as Loadable Kernel Modules (LKMs) and have the file extension .ko (kernel object). They allow the kernel to support additional hardware, filesystems, or other low-level features. The following is exemplary code for a basic Kernel Level Module:
#include <linux/module.h>// Core header for kernel modules
#include <linux/kernel.h>// Kernel-related functions
#include <linux/init.h>// Macros for module initialization and cleanup
// Module Initialization
static int __init my_module_init(void) {printk(KERN_INFO “Hello, Kernel! My module has been loaded.\n”); return 0; // Return 0 for successful load }// Module Cleanup static void __exit my_module_exit(void) {printk(KERN_INFO “Goodbye, Kernel! My module has been removed.\n”); }
// Register module entry and exit points
module_init(my_module_init);
module_exit(my_module_exit);

79) Yet another way the process control module could be implemented in software would be via an executable file. An executable file is a file that contains a program in a format the operating system can directly execute. It includes machine code and metadata required to run the program. Executable files are the final output of the compilation and linking process for software, and they can perform tasks independently or in conjunction with other files like libraries or scripts.
80) Yet another way the process control module could be implemented in software would be via a jar file. A .jar file (short for Java Archive) is a package file format used to distribute Java applications, libraries, or components. It is essentially a compressed archive of multiple files, including Java bytecode (. class files), metadata, and resources (e.g., images, configuration files). The .jar format is based on the standard ZIP file format with added functionality for Java.

81) Yet another way the process control module could be implemented in software would be via a library file. A library file is a collection of precompiled code, data, or resources that can be reused by programs. Libraries are designed to provide modular functionality to applications, reducing redundancy and making development more efficient. They enable developers to integrate complex features without rewriting code from scratch.

What is claimed is

1. A system for detecting and mitigating malware by first detecting a computer process when it is first launched; interrupting said process to perform at least two checks to see if the process is authorized to operate on this device; at least one of those checks being a manual approval if this is the first time that process has launched; further making a backup of designated files to an isolated folder to secure said files prior to launching the process;

2. The system of claim 1 wherein the manual check must be done by an administrator with appropriate credentials.

3. The system of claim 1 wherein the second check performed is against a blacklist, and if not on the blacklist is allowed to execute; should the process be in the blacklist and thus fail the blacklist check, an alert is registered regarding the attempt to launch a blacklist program; an alert is provided regarding the attempt to launch a program that is on the blacklist; the event is logged; and the process is prevented from launching.

4. The system of claim 1 wherein the second checked performed is against a whitelist, and if on the whitelist, is allowed to execute; should the process not be on the whitelist and thus fail the whitelist check, an alert is provided regarding the attempt to launch a program not on the whitelist; the event is logged; and the process is prevented from launching.

5. The system of claim 1 wherein second check is a check of the processes digital signature to confirm the validity of the digital signature and if the digital signature is valid, allowing it to execute; should the processes digital signature not be validated, an alert is provided regarding the attempt to launch a program without a valid signature; the event is logged; and the process is prevented from launching.

6. The system of claim 1 wherein after the backup of sensitive files is created, that location is disconnected.

7. The system of claim 1 wherein the process control module is implemented as a software file such as one or more of the following dynamic linked library (.dll), executable (.exe), shared object file (.so), position independent executable, library file (.lib), java file (.jar), kernel level module (.ko), or similar functioning code module.

8. The system of claim 1 wherein the process control module is implemented as hardware such as an embedded chip, System on a Chip (SoC), application specific integrated circuit (ASIC), Field Programmable Gate Array (FPGA), or similar functioning hardware module.

9. The system of claim 1 wherein there is a configuration screen that allows a user to select what checks to perform as well as to configure the backup options including at least one of the following: backup location, files to backup, the type of backup to perform, and whether to disconnect after the backup.

10. A method for detecting and mitigating malware by first detecting a computer process when it is first launched; interrupting said process to perform at least two checks to see if the process is authorized to operate on this device; at least one of those checks being a manual approval if this is the first time that process has launched; further making a backup of designated files to an isolated folder to secure said files prior to launching the process;

10. The method of claim 10 wherein the manual override must be done by an administrator with appropriate credentials.

11. The method of claim 10 wherein the second check performed is against a blacklist, and if not on the blacklist is allowed to execute; should the process be in the blacklist, an alert is registered regarding the attempt to launch a blacklist program; an alert is provided regarding the attempt to launch a program that is on the blacklist; the event is logged; and the process is prevented from launching.

12. The method of claim 10 wherein the second checked performed is against a whitelist, and if not on the whitelist, is allowed to execute; should the process not be on the whitelist, an alert is provided regarding the attempt to launch a program not on the whitelist; the event is logged; and the process is prevented from launching.

13. The method of claim 10 wherein second check is a check of the processes digital signature to confirm the validity of the digital signature; should the processes digital signature not be validated; an alert is provided regarding the attempt to launch a program without a valid signature; the event is logged; and the process is prevented from launching.

14. The method of claim 10 wherein after the backup is made, the backup location is disconnected.
